(19) United States
(12) Patent Application Publication
(10) Pub. No.: US 2013/0174866 A1
(43) Pub. Date: Jul. 11, 2013

(54) WIDE GAUZE-TYPE DENTAL FLOSS AND DISPENSER

(71) Applicants: Adrian Harold Sambrooke Slack, Sippy Downs (AU); Maria Elizabeth Slack, Sippy Downs (AU)

(72) Inventors: Adrian Harold Sambrooke Slack, Sippy Downs (AU); Maria Elizabeth Slack, Sippy Downs (AU)

(21) Appl. No.: 13/822,397

(22) PCT Filed: Sep. 7, 2011
(86) PCT No.: PCT/AU11/01153

§ 371 Date: Mar. 12, 2013

(30) Foreign Application Priority Data
Sep. 14, 2010 (AU) 2010904131
Nov. 16, 2010 (AU) 2010241452

(51) Int. Cl. A61C 15/04

(52) U.S. Cl. CPC A61C 15/043
USPC 132/325; 132/321

(57) ABSTRACT

The present invention relates to a dental cleaning aid. The cleaning aid includes a webbed cleaning material and a dispenser for dispensing the cleaning material. The dispenser includes a cutter having a smooth blade for cutting a length of the cleaning material. Advantageously, the webbed material provides improved larger inter-proximal space cleaning when compared with smoother polymeric materials. The smooth blade desirably cleanly cuts the webbed material when compared with a serrated blade which would otherwise undesirably snag and stretch the webbed material.

### TECHNICAL FIELD

The present invention relates to a dental cleaning aid.

### BACKGROUND

The reference to any prior art in this specification is not, and should not be taken as an acknowledgement or any form of suggestion that the prior art forms part of the common general knowledge.

Dental floss is a bundle of thin nylon filaments or a plastic (Teflon or polyethylene) ribbon used to remove food and dental plaque from teeth. The floss is gently inserted between the teeth and scraped along the teeth sides, especially close to the gums. Dental floss may also be supplied as a tape, usually 1 to 2 mm wide, made of similar materials.

A dental implant is an artificial tooth root replacement and is used in prosthetic dentistry to support restorations that resemble a tooth or group of teeth. A common type of implant includes posts embedded in a patient's jaw bone. A structure bearing artificial teeth is then supported by the posts. The gaps between the posts, known in the art as interproximal spaces, can be relatively large when compared with the spacing between teeth, and prone to accumulate food particles, debris and plaque.

A denture is a partial or complete set of artificial teeth for either the upper or lower jaw. The denture is supported by a plate shaped to fit snugly against the palate or the lower jaw. Partial dentures are dentures providing one or more artificial teeth, positioned between the natural teeth. When a partial denture is removed, a gap between the teeth is evident and the sides of the natural teeth are exposed.

The main reason for tooth decay and dental prosthesis failure is poor oral hygiene. Plaque and calculus are irritants which lead to gum infection. Gingivitis (gum infection) and periodontitis (bone infection) can develop around implants as well as around natural teeth, leading to implant loss as well as tooth loss. In implants this is referred to as peri-mucositis and peri-implantitis. Poor oral hygiene can cause periodontitis as well as decay around natural teeth which may lead to tooth loss.

Dental implants and dentures are high cost items. Whilst it is important to clean dental implants and natural teeth to ensure that they do not fail, a fine thread-like dental floss is not well suited to cleaning the wide gaps where a tooth is missing or where a tooth is more exposed due to bone loss from periodontitis. JP63300756 discloses a dental cleaning aid having the form of a single strip of gauze or water-resistant Japanese paper. This device may not be convenient or easy-to-use when cleaning large inter-dental spaces. Furthermore U.S. Pat. No. 5,159,943 discloses a floss-type dental cleaner mounted in a roll dispenser. This floss is specialty floss with alternate threader portions and floss portions, suitable for cleaning fine inter-dental gaps.

US 2007/0068550 discloses a dental cleaning aid including a dispenser for dispensing polymeric and elastic cleaning material. The dispenser has a serrated blade for piercing the cleaning material when cutting a length of cleaning material.

The applicant has perceived the need for an alternative dental cleaning aid.

### SUMMARY OF THE INVENTION

According to one aspect of the present invention, there is provided a dental cleaning aid including:
a webbed cleaning material; and
a dispenser for dispensing the cleaning material, the dispenser including a cutter having a smooth blade for cutting a length of the cleaning material.

Advantageously, the webbed material provides improved larger inter-proximal space cleaning when compared with smoother polymeric materials. The smooth blade desirably cleanly cuts the webbed material when compared with a serrated blade which would otherwise undesirably snag and stretch the webbed material.

The webbed cleaning material is a hydroentangled (or spunlaced) non-woven material including polymeric and woodpulp fibres joined together with a hydro-entanglement process. The polymeric fibres may be polyester fibres. The material may be moisture-absorbent.

The cleaning material may have a basis weight of 54 g/m², cut with the machine direction in the length of the strip. The width of the strip may be in the range from 10 to 20 mm. The material may have a crepe finish to provide suitable abrasive properties for the cleaning of teeth. The material may be coated with various flavorants, colourants, or an antibacterial agent.

The dispenser may include a container for containing a spool upon which the webbed material is wound. The blade may be cantilevered and extend obliquely from the container. The container may have a lid for covering the blade.

According to another aspect of the present invention, there is provided a dental cleaning aid including:
a webbed cleaning material in the form of gauze-like or meshed cleaning material; and
a dispenser for dispensing the cleaning material, the dispenser including a cutter having a smooth blade for cutting a length of the cleaning material;
wherein the cleaning material is a hydroentangled or spunlaced non-woven material including polymeric fibres and woodpulp fibres joined together with a hydro-entanglement or spunlaced process.

According to another aspect of the present invention, there is provided a dental cleaning aid including hydroentangled or spunlaced non-woven material including polymeric fibres and woodpulp fibres joined together with a hydro-entanglement or spunlaced process.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a view of a dental cleaning aid in accordance with an embodiment of the present invention showing the gauze ribbon-like floss mounted in a spool-type dispenser;

FIG. 2 is a view of a piece of webbed or meshed floss cut to length and ready for use;

FIG. 3 shows a model of a patient's teeth with one tooth missing, being cleaned with a piece of the floss of FIG. 2.

### DETAILED DESCRIPTION OF PREFERRED EMBODIMENTS

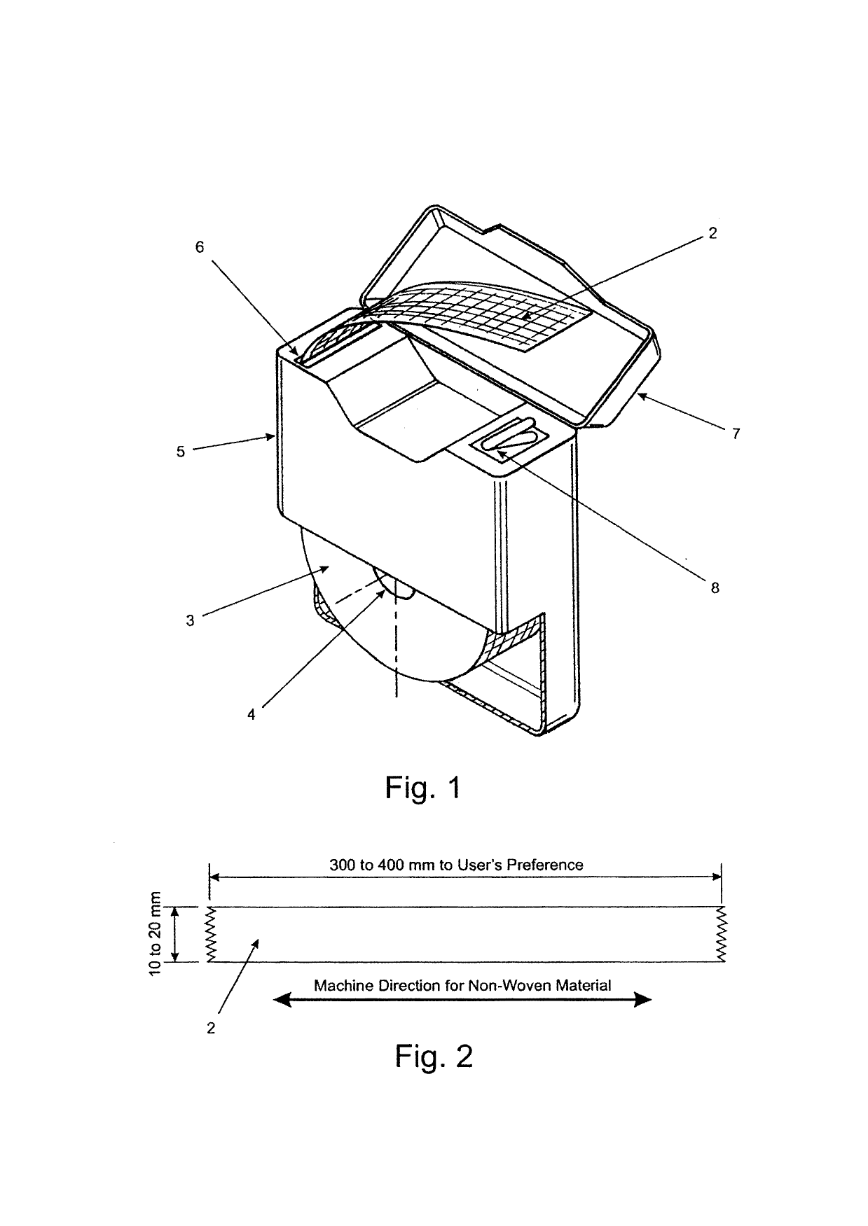

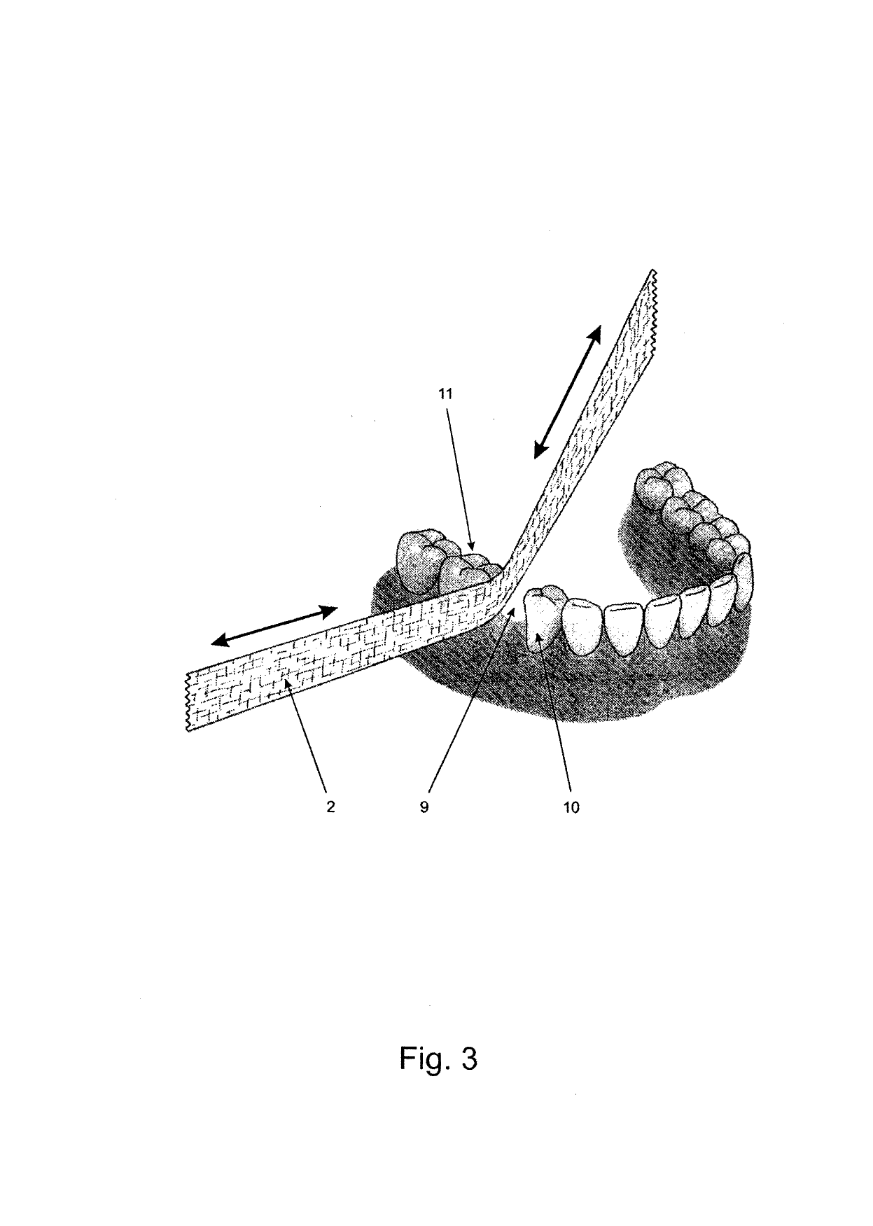

According to an embodiment of the present invention, there is provided a disposable dental cleaning aid 2 as shown in FIGS. 1 to 3. The dental cleaning aid 2 is suitable for cleaning the long edge of an exposed tooth surface as shown in FIG. 3, or for cleaning any wide inter-dental space which may be between natural teeth, crowns, or implants.

Turning to FIG. 1, the aid 2 includes a roll of gauze cleaning material 3 on a bobbin 4 mounted in a box-like dispenser 5. The gauze cleaning material 3 is meshed or webbed. Advantageously, the webbed material provides improved larger inter-proximal space cleaning when compared with smoother polymeric materials. The webbed cleaning material is a hydro-entangled (or spunlaced) non-woven material including polyester and wood pulp fibres joined together with a hydro-entanglement process. The material is moisture-absorbent and can be coated with various flavorants, colourants, or an antibacterial agent.

The cleaning material has a basis weight of 54 g/m², cut with the machine direction in the length of the strip. The width of the strip is in the range from 10 to 20 mm. The webbed material has a crepe finish to provide suitable abrasive properties for the cleaning of teeth.

The dispenser 5 includes a box-like container for containing a spool or bobbin 4 upon which the webbed cleaning material 3 is wound. The end of the gauze can freely be pulled from the roll. The dispenser 5 includes a cutter 8 having a smooth blade for cutting a length of the cleaning material 3. A length of gauze 3 may be cut from the roll using the cutter 8. The smooth blade desirably cleanly cuts the webbed material 3 when compared with a serrated blade which would otherwise undesirably snag and stretch the webbed material. The blade is cantilevered and extends obliquely from the container. The container also has a hinged lid 7 for covering the blade for safety purposes.

With reference to FIG. 2, the gauze 2 consists of a strip of material cut into a length according to the user's preference.

Turning to FIG. 3, the dental model includes a healthy set of teeth with one tooth missing. A wide gap 9 to be cleaned is defined between the front tooth 10 and rear tooth 11. During cleaning, the gauze strip can be readily placed in the wide gap 9 and is moved back and forth to clean the gap. Non-woven fabric is well adapted to engaging with food, debris or plaque owing to its inherently abrasive characteristics. Advantageously, the aid 2 enables the patient to properly clean the sides of the teeth 10 and 11 without requiring the services of a dental professional.

A method for forming the dental cleaning aid 2 is now described. The method involves the step of cutting the gauze into continuous strips of the correct width from a source roll. The gauze strip is fastened to a plastic spool 4. The spool is wound under tension to make up a roll 3 of the appropriate diameter. The roll of gauze is placed in the dispenser 5 with the free end passing over the guide 6. The dispenser has a hinged lid 7 which is closed with a snap action to cover the top of the dispenser.

The method may further involve the step of impregnating the gauze 2 with flavored particles or an antibacterial agent before it is wound onto the spool 4.

A person skilled in the art will appreciate that many embodiments and variations can be made without departing from the ambit of the present invention.

The dimensions of the dental cleaning aid 2 shown in the Figures are in millimetres, and are by way of example only. Likewise the weight of the fabric, or the constituents of the fabric may vary, and are by way of example only.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A dental cleaning aid including:
a webbed cleaning material; and
a dispenser for dispensing the cleaning material, the dispenser including a cutter having a smooth blade for cutting a length of the cleaning material;
wherein the webbed cleaning material is a hydroentangled or spunlaced non-woven material including polymeric fibres and woodpulp fibres joined together with a hydro-entanglement or spunlaced process.

2. A dental cleaning aid as claimed in claim 1, wherein the polymeric fibres are polyester fibres.

3. A dental cleaning aid as claimed in claim 1, wherein the cleaning material is moisture-absorbent.

4. A dental cleaning aid as claimed in claim 1, wherein the cleaning material has a basis weight of 54 g/m².

5. A dental cleaning aid as claimed in claim 1, wherein the cleaning material is an elongate strip having a width in the range from 10 to 20 mm.

6. A dental cleaning aid as claimed in claim 1, wherein the cleaning material has a crepe finish.

7. A dental cleaning aid as claimed in claim 1, wherein the cleaning material is coated with any one of flavorants, colourants, and an antibacterial agent.

8. A dental cleaning aid as claimed in claim 1, wherein the dispenser includes a container for containing a spool upon which the webbed cleaning material is wound.

9. A dental cleaning aid as claimed in claim 8, wherein the blade is cantilevered and extends obliquely from the container.

10. A dental cleaning aid as claimed in claim 9, wherein the container has a hinged lid for covering the blade.

11. A dental cleaning aid including:
a webbed cleaning material in the form of gauze-like or meshed cleaning material; and
a dispenser for dispensing the cleaning material, the dispenser including a cutter having a smooth blade for cutting a length of the cleaning material;
wherein the cleaning material is a hydroentangled or spunlaced non-woven material including polymeric fibres and woodpulp fibres joined together with a hydro-entanglement or spunlaced process.

12. A dental cleaning aid as claimed in claim 11, wherein the polymeric fibres are polyester fibres.

13. A dental cleaning aid as claimed in claim 11, wherein the cleaning material is moisture-absorbent.

14. A dental cleaning aid as claimed in claim 11, wherein the cleaning material has a basis weight of 54 g/m².

15. A dental cleaning aid as claimed in claim 11, wherein the cleaning material is an elongate strip having a width in the range from 10 to 20 mm.

16. A dental cleaning aid as claimed in claim 11, wherein the cleaning material has a crepe finish.

17. A dental cleaning aid as claimed in claim 11, wherein the dispenser includes a container for containing a spool upon which the cleaning material is wound.

18. A dental cleaning aid as claimed in claim 17, wherein the blade is cantilevered and extends obliquely from the container and the container has a hinged lid for covering the blade.

19. A dental cleaning aid including hydroentangled or spunlaced non-woven material including polymeric fibres and woodpulp fibres joined together with a hydro-entanglement or spunlaced process.
